(19) United States
(12) Patent Application Publication
(10) Pub. No.: US 2021/0133422 A1
(43) Pub. Date: May 6, 2021

(54) METHOD AND ELECTRONIC DEVICE FOR DISPLAYING GRAPHICAL OBJECTS FOR FINGERPRINT INPUT

(71) Applicant: Samsung Electronics Co., Ltd., Gyeonggi-do (KR)

(72) Inventors: Siwoo LEE, Gyeongsangbuk-do (KR); Kwonseung SHIN, Gyeonggi-do (KR); Jeongseob KIM, Daegu (KR); Yonggil HAN, Gyeongsangbuk-do (KR); Hyeonho KIM, Gyeongsangbuk-do (KR)

(21) Appl. No.: 16/478,234

(22) PCT Filed: Dec. 22, 2017
(86) PCT No.: PCT/KR2017/015394

§ 371 Date: Jul. 16, 2019

(30) Foreign Application Priority Data
Feb. 3, 2017 (KR) 10-2017-0015482

(51) Int. Cl. G06K 9/00; G06F 3/041; G06F 3/0481; G06F 3/01

(52) U.S. Cl. CPC G06K 9/00013; G06F 3/016; G06F 3/0481; G06F 3/041

(57) ABSTRACT

Various embodiments of the disclosure provide a method and an electronic device for displaying a graphical object for fingerprint input, comprising: a display including a touch panel; a fingerprint sensor formed on at least a part of an area of the display; and a processor, wherein the processor displays a graphical object in a first area which at least includes the at least a part of an area of the fingerprint sensor via the display; obtains fingerprint input through the fingerprint sensor and position information associated with the fingerprint input through the touch panel; and is configured to display the graphical object in a second area which at least includes the at least a part of an area on the basis of at least the position information, and thus when the electronic device obtains fingerprint information of a user, stores the touch information obtained through the touch panel together with the fingerprint information obtained through the fingerprint sensor, and in fingerprint authentication, preferentially matches the fingerprint information corresponding to the touch information, so that the time required for fingerprint recognition can be shortened and the matching speed can be improved. Various embodiments other than the embodiments disclosed in the disclosure are possible.

### TECHNICAL FIELD

Various embodiments of the disclosure relate to a method for displaying a graphical object for a fingerprint input in an electronic device.

### BACKGROUND ART

As electronic devices such as portable terminals become popular, a great variety of functions are being provided in such electronic devices.

The electronic device may include various security functions to protect user's personal information or privacy information.

For example, the electronic device may offer a fingerprint recognition service as one of various security functions. In general, the fingerprint recognition service is applied for security authentication of the electronic device.

### DISCLOSURE OF INVENTION

### Technical Problem

When a user performs a fingerprint authentication in the electronic device where a fingerprint sensor is formed on at least a part of a display, an actual touch position of the user may be different from a position of an object (e.g., a fingerprint authentication indication) on a user interface (UI).

Various embodiments of the disclosure may provide a method and electronic device for displaying a graphical object for a fingerprint input, which are capable of storing together user's fingerprint information acquired through a fingerprint sensor and user's touch information (e.g., touch coordinates, a touch direction, a touch angle, etc.) acquired through a touch panel, preferentially matching the fingerprint information corresponding to the touch information at the time of fingerprint authentication, thereby reducing a time required for fingerprint recognition, and improving a matching speed.

Various embodiments of the disclosure may provide a method and electronic device for displaying a graphical object for a fingerprint input, which are capable of, when failing to perform authentication through user's fingerprint information, changing a display position of an object on a user interface (UI), based on user's touch information, or offering a vibration feedback corresponding to the position of the UI object.

Various embodiments of the disclosure may provide a method and electronic device for displaying a graphical object for a fingerprint input, which are capable of setting a display position of a user interface (UI) object for acquiring a user's fingerprint, based on a user's previous touch position on an object (e.g., keyboard, button, icon, etc.).

### Solution to Problem

An electronic device according to various embodiments of the disclosure may include a display including a touch panel; a fingerprint sensor formed in an at least partial area of the display; and a processor, wherein the processor may be configured to display a graphical object in a first area including the at least partial area through the display; to acquire a fingerprint input through the fingerprint sensor and position information associated with the fingerprint input through the touch panel; and to display the graphical object in a second area including the at least partial area, at least based on the position information.

A method for displaying a graphical object for a fingerprint input according to various embodiments of the disclosure may include, at a processor, displaying a graphical object in a first area including the at least partial area through the display; at the processor, acquiring a fingerprint input through the fingerprint sensor and position information associated with the fingerprint input through the touch panel; and at the processor, displaying the graphical object in a second area including the at least partial area, at least based on the position information.

A computer-readable recording medium in which a program for controlling a function of an electronic device according to various embodiments of the disclosure is recorded may perform a method for displaying a graphical object for a fingerprint input in the electronic device that includes a display with a touch panel, and a fingerprint sensor formed in an at least partial area of the display, the method including displaying a graphical object in a first area including the at least partial area through the display; acquiring a fingerprint input through the fingerprint sensor and position information associated with the fingerprint input through the touch panel; and displaying the graphical object in a second area including the at least partial area, at least based on the position information.

### Advantageous Effects of Invention

According to various embodiments of the disclosure, it is possible to store together user's fingerprint information acquired through a fingerprint sensor and user's touch information (e.g., touch coordinates, a touch direction, a touch angle, etc.) acquired through a touch panel, preferentially match the fingerprint information corresponding to the touch information at the time of fingerprint authentication, thereby reduce a time required for fingerprint recognition, and improve a matching speed.

According to various embodiments of the disclosure, it is possible to, when failing to perform authentication through user's fingerprint information, change a display position of an object on a user interface (UI), based on user's touch information, or offer a vibration feedback corresponding to the position of the UI object.

According to various embodiments of the disclosure, it is possible to set a display position of a user interface (UI) object for acquiring a user's fingerprint, based on a user's previous touch position on an object (e.g., keyboard, button, icon, etc.).

### BRIEF DESCRIPTION OF DRAWINGS

FIG. 1 is a block diagram illustrating a network environment including an electronic device according to various embodiments of the disclosure.

FIG. 2 is a block diagram illustrating an electronic device according to various embodiments of the disclosure.

FIG. 3 is a block diagram illustrating a program module according to various embodiments of the disclosure.

FIG. 4 is a block diagram illustrating a configuration of an electronic device according to various embodiments of the disclosure.

FIG. 5 is a schematic diagram illustrating a partial configuration of an electronic device according to various embodiments of the disclosure.

FIG. 6 is a diagram illustrating an example of acquiring touch information at an electronic device according to various embodiments of the disclosure.

FIG. 7 is a diagram illustrating an example of acquiring touch information at an electronic device and then determining a candidate group of fingerprint information stored in a memory at fingerprint registration according to various embodiments of the disclosure.

FIG. 8 is a diagram illustrating an example of changing a position of a user interface (UI) object for acquiring fingerprint information in case of a failure of fingerprint authentication at an electronic device according to various embodiments of the disclosure.

FIG. 9 is a diagram illustrating an example of identifying a touch pattern of a user's touch action on a sensing area of a user interface (UI) object at an electronic device according to various embodiments of the disclosure.

FIG. 10 is a diagram illustrating an example of indicating a position of a fingerprint sensor through at least one vibrating device at an electronic device according to various embodiments of the disclosure.

FIG. 11 is a flow diagram illustrating a method for displaying a user interface (UI) object (e.g., a graphical object) for a fingerprint input at an electronic device according to various embodiments of the disclosure.

FIG. 12 is a flow diagram illustrating a method for performing fingerprint authentication of a user through fingerprint information and touch information at an electronic device according to various embodiments of the disclosure.

FIG. 13A is a flow diagram illustrating a method for changing and displaying a user interface (UI) object to acquire fingerprint information of a user in case of a failure of fingerprint authentication at an electronic device according to various embodiments of the disclosure.

FIG. 13B is a flow diagram illustrating a method for controlling a plurality of vibrating devices to acquire fingerprint information of a user in case of a failure of fingerprint authentication at an electronic device according to various embodiments of the disclosure.

FIG. 14 is a diagram illustrating a system architecture of an electronic device according to various embodiments of the disclosure.

### MODE FOR THE INVENTION

Hereinafter, various embodiments of the disclosure are described in detail with reference to accompanying drawings. The embodiments and terms used herein are not intended to limit the technology disclosed in specific forms and should be understood to include various modifications, equivalents, and/or alternatives to corresponding embodiments.

In the drawings, similar reference numbers are used to indicate similar constituent elements. As used herein, singular forms are intended to include the plural forms as well, unless the context clearly indicates otherwise.

In the disclosure, the expression “A or B” or “at least one of A and/or B” is intended to include any possible combination of enumerated items. In the present disclosure, expressions such as “1st” or “first”, “2nd” or “second”, etc. may modify various components regardless of the order and/or the importance but do not limit corresponding components. When it is mentioned that a certain (first) component is “(functionally or communicatively) connected” to or “accessed” by another (second) component, it may be understood that the component is directly connected to or accessed by the other component or that still other (third) component is interposed between the two components.

In the disclosure, the expression “configured to˜” may be interchangeably used with other expressions “suitable for˜”, “having a capability of˜”, “changed to˜”, “made to˜”, “capable of˜”, and “designed for” in hardware or software. The expression “device configured to˜” may denote that the device is “capable of˜” with other devices or components. For example, a “processor configured to (or set to) perform A, B, and C” may mean a dedicated processor (e.g., an embedded processor) for performing a corresponding operation or a general-purpose processor (e.g., a central processing unit (CPU) or an application processor (AP)) which executes corresponding operations by executing one or more software programs which are stored in a memory device.

According to various embodiments of the disclosure, an electronic device may include at least one of a smart phone, a tablet PC, a mobile phone, a video phone, an e-book reader, a desktop PC, a laptop PC, a netbook computer, a workstation, a server, a personal digital assistant (PDA), a portable multimedia player (PMP), an MP3 player, a medical device, a camera, and a wearable device. The wearable device may include at least one of an appcessory type device (e.g. a watch, a ring, a bracelet, an anklet, a necklace, glasses, contact lens, and head-mounted-device (HMD), a textile or clothes-integrated device (e.g., electronic clothes), a body-attached device (e.g., skin pad and tattoo), and a bio-implemented circuit. According to various embodiments, the electronic device may include at least one of television (TV), a digital video disk (DVD) player, an audio player, an air conditioner, a cleaner, an oven, a microwave oven, a washing machine, an air cleaner, a set-top box, a home automation control panel, a security control panel, a media box (e.g., Samsung HomeSync™, Apple TV™, or Google TV™), game consoles (e.g., Xbox™, PlayStation™), an electronic dictionary, an electronic key, a camcorder, and an electronic frame.

According to an alternative embodiment, the electronic device may include at least one of a medical device (such as portable medical measuring devices (including a glucometer, a heart rate monitor, a blood pressure monitor, and a body temperature thermometer), a magnetic resonance angiography (MRA) device, a magnetic resonance imaging (MRI) device, a computed tomography (CT) device, a camcorder, and a microwave scanner), a navigation device, a global navigation satellite system (GNSS), an event data recorder (EDR), a flight data recorder (FDR), an automotive infotainment device, marine electronic equipment (such as marine navigation system and gyro compass), aviation electronics (avionics), security equipment, an automotive head unit, an industrial or household robot, a drone, an automatic teller machine (ATM), a point of sales (POS) terminal, and an Internet-of-things (IoT) device (such as electric bulb, sensor, sprinkler system, fire alarm system, temperature controller, street lamp, toaster, fitness equipment, hot water tank, heater, and boiler). According to an embodiment of the present disclosure, the electronic device may include at least one of furniture, a part of a building/structure, a part of a vehicle, an electronic board, an electronic signature receiving device, a projector, and a sensor (such as water, electricity, gas, and electric wave meters). According to various embodiments of the present disclosure, the electronic device may be flexible or a combination of at least two of the aforementioned devices. According to an embodiment of the present disclosure, the electronic device is not limited to the aforementioned devices.

In the disclosure, the term “user” may denote a person who uses the electronic device or a device (e.g., artificial intelligent electronic device) which uses the electronic device.

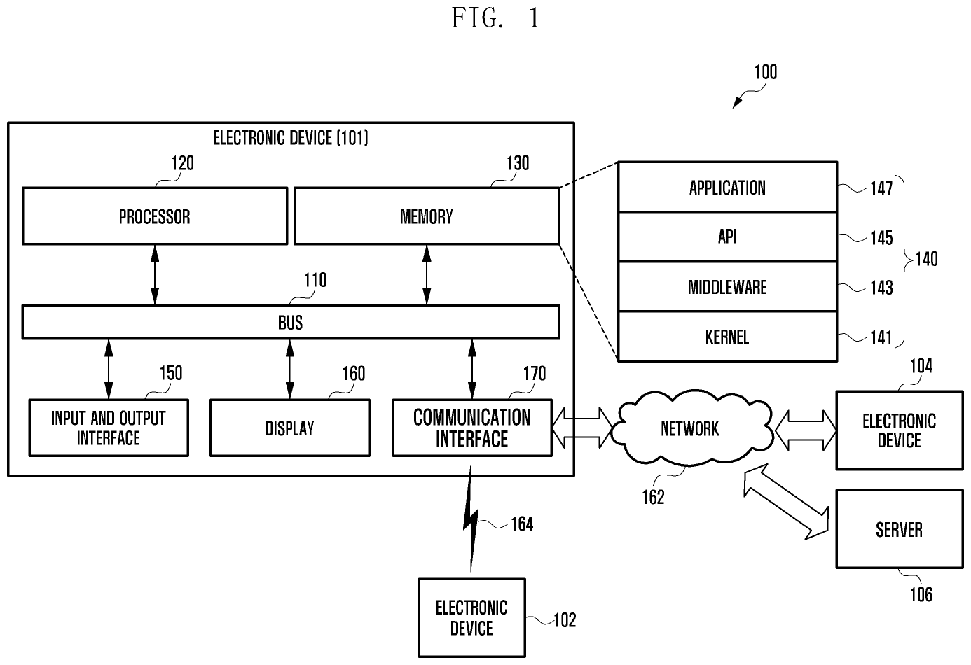

FIG. 1 is a block diagram illustrating a network environment 100 including an electronic device 101 according to various embodiments of the disclosure.

Referring to FIG. 1, an electronic device 101, 102 or 104 or a server 106 may be connected to each other via a network 162 or short-range communication 164.

The electronic device 101 may include a bus 110, a processor 120, a memory 130, an input/output interface 150, a display 160, and a communication interface 170. In an embodiment, the electronic device 101 may be configured without at least one of the aforementioned components or with another component. The bus 110 may include a circuit for interconnecting components 110 to 170 such that the components communicate signal (e.g., control message and data). The processor 120 may include at least one of a central processing device, an application processor, and a communication processor (CP). The processor 120 may execute operation related to the control of and/or communication among the other components constituting the electronic device 101 and perform data processing.

The memory 130 may include a volatile and/or non-volatile memory. The memory 130 may store a command or data associated with at least one of the components of the electronic device 101. According to an embodiment, the memory 130 may store software and/or programs 140. The programs 140 may include a kernel 141, a middleware 143, an application programming interface (API) 145, and/or an application program (or “application”) 147. At least part of the kernel 141, middleware, and API 145 may be referred to as operating system. The kernel 141 may control or manage system resources (e.g., bus 110, processor 120, and memory 130) for use in executing operations or functions implemented in other programming modules (e.g., middleware 143, API 145, and application program 147). Further, the kernel 141 can provide an interface through which the middleware 143, the API 145, and/or the application 147 can access an individual element of the electronic device 101 and then control and/or manage system resources.

The middleware 143 may relay the data communicated between the API 145 or the application program 147 and the kernel 141. The middleware 143 may process at least one task request received from the application program 147 according to priority. For example, the middleware 143 may assign a priority to at least one of the application programs 147 for use of the system resources (e.g., the bus 110, the processor 120, and the memory 130) of the electronic device 101 and process the at least one task request according to the assigned priority. The API 145 may include an interface for controlling the functions provided by the kernel 141 and the middle 143 and includes at least one interface or function (e.g., command) for file control, window control, and video control, and text control, by way of example. The input/output interface 150 may relay a command or data input by a user or via an external electronic device to other component(s) of the electronic device 101 and output a command or data received from other component(s) of the electronic device 101 to the user or the external electronic device.

Examples of the display 160 may include a liquid crystal display (LCD), a light emitting diodes display (LED), an organic LED (OLED) display, a micro electro mechanical systems (MEMS) display, and an electronic paper display. The display 160 may display various contents (e.g., text, image, video, icon, and symbol) to the user by way of example. The display 160 may include a touch screen that is capable of receiving a touch, gesture, proximity, or hovering input made with an electronic pen or part of the user's body by way of example. The communication interface 170 may set up a communication channel between the electronic device 101 and an external device (e.g., first external electronic device 102, second external electronic device 104, and server 106). For example, the communication interface 170 may connect to the network 162 through a wireless or wired communication channel to communicate with the external electronic device (e.g., second external electronic device 104 and server 106).

Examples of the wireless communication may include cellular communications using at least one of LTE, LTE Advanced (LTE-A), code division multiple access (CDMA), wideband CDMA (WCDMA), universal mobile telecommunications system (UMTS), Wireless Broadband (WiBro), and global system for mobile communications (GSM). According to an embodiment, examples of the wireless communication may include communications using at least one of wireless fidelity (Wi-Fi), Bluetooth, Bluetooth low energy (BLE), Zigbee, near field communication (NFC), magnetic secure transmission, radio frequency (RF), and body area network (BAN). According to an embodiment, examples of the wireless communication may include GNSS communication. Examples of the GNSS may include a global positioning system (GPS), a global navigation satellite system (Glonass), a Beidou navigation satellite system (hereinafter, referred to as “Beidou”), and Galileo (the European global satellite-based navigation system). In the following description, the terms “GPS” and “GNSS” are interchangeably used. Examples of the wired communication may include communications using at least one of universal serial bus (USB), high definition multimedia interface (HDMI), recommended standard 233 (RS-232), power line communication, and plain old telephone service (POTS). The network 162 may be a telecommunication network including a computer network (e.g., LAN and WAN), Internet, and telephony network, by way of example.

Each of the first and second external electronic devices 102 and 104 may be identical to or different from the electronic device 101 in type. According to various embodiments, all or part of the operations being executed at the electronic device 101 may be executed at one or more other electronic devices (e.g., electronic devices 102 and 104 and server 106). According to an embodiment, if it is necessary for the electronic device 101 to execute a function or service automatically or in response to a request, the electronic device 101 may request to another device (e.g., electronic devices 102 and 104 and server 106) for executing at least part of related functions on its behalf or additionally. The other electronic device (e.g., electronic devices 102 and 104 and server 106) may execute the requested function or additional function and notify the electronic device 101 of the execution result. The electronic device 101 may provide the requested function or service with execution result in itself or after performing additional processing thereon. In order to accomplish this, it may be possible to use a cloud computing, a distributed computing, or a client-server computing technology.

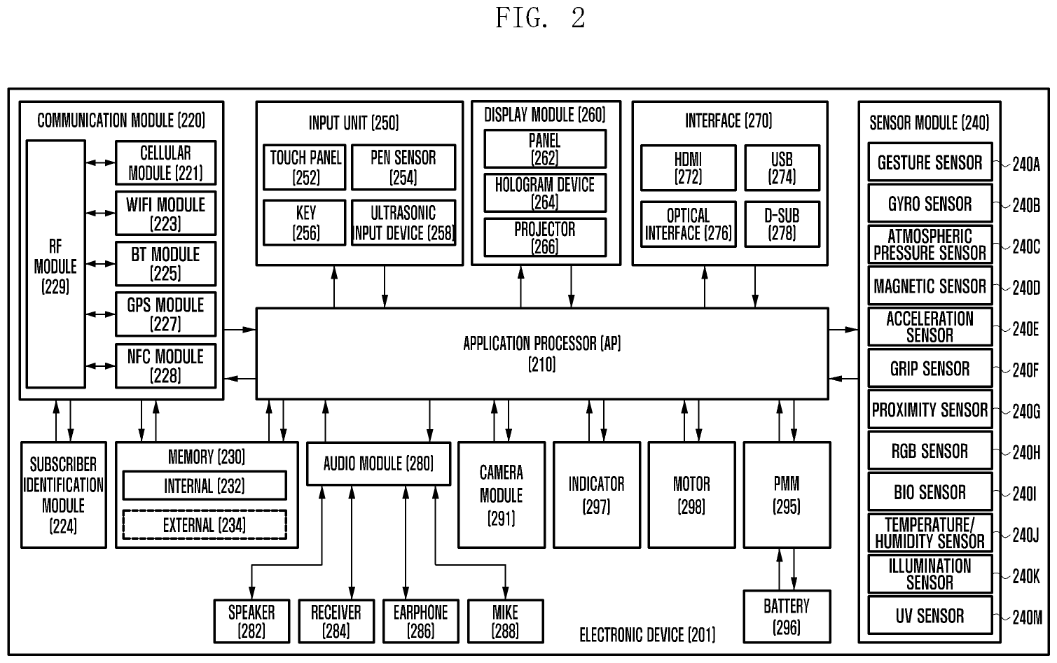

FIG. 2 is a block diagram illustrating an electronic device 201 according to various embodiments.

The electronic device 201 may include all or part of the electronic device 101 depicted in FIG. 1. The electronic device 201 may include at least one processor (e.g., AP 210), a communication module 220, a subscriber identity module (SIM) 224, a memory 230, a sensor module 240, an input device 250, a display 260, an interface 270, an audio module 280, a camera module 291, a power management module 295, a battery 296, an indicator 297, and a motor 298.

The processor 210 may execute the operation system or application program to control a plurality of hardware or software components connected to the processor 210 and perform various data processing and operations. The processor 210 may be implemented in the form of system on chip (SoC) by way of example. According to an embodiment, the processor 210 may also include a graphic processing unit (GPU) and/or an image signal processor. The processor 210 may include at least part (e.g., cellular module 221) of the components depicted in FIG. 2). The processor 210 may load the command or data received from at least one of other components (e.g., non-volatile memory) onto the volatile memory and store processed result data in the non-volatile memory.

The communication module 220 may have a configuration identical with or similar to that of the communication interface 170 by way of example. For example, the communication module 220 may include a cellular module 221, a Wi-Fi module 223, a Bluetooth module 225, a GNSS module 227, an NFC module 228, and an RF module 229. The cellular module 221 may provide a voice call service, a video call service, a text messaging service, and an Internet access service via a communication network, by way of example. According to an embodiment, the cellular module 221 may identity and authenticate the electronic device 201 and perform identification and authentication on the electronic device 201 in the communication network by means of the subscriber identity module (SIM) 224. According to an embodiment, the cellular module 221 may perform part of the functions of the processor 210. According to an embodiment, the cellular 221 may include a communication processor (CP). According to an embodiment, part of the cellular module 221, the Wi-Fi module 223, the Bluetooth module 225, the GNSS module 227, and the NFC module 228 (e.g., two or more) may be included in an integrated chip (IC) or an IC package. The RF module 229 may transmit/receive a communication signal (e.g., RF signal). The RF module 229 may include a transceiver, a power amplification module (PAM), a frequency filter, a low noise amplifier (LNA), and an antenna by way of example. According to an alternative embodiment, at least one of the cellular module 221, the Wi-Fi module 223, the Bluetooth module 225, the GNSS module 227, and the NFC module 228 may transmit/receive an RF signal via a separate RF module. The SIM 224 may include a card containing a subscriber identity module or an embedded SIM and contain unique identity information (e.g., integrated circuit card identifier (ICCID)) or subscriber information (e.g., international mobile subscriber identity (IMSI)).

The memory 230 (e.g., memory 130) may include an internal memory 232 and an external memory 234 by way of example. The internal memory 232 may include at least one of a volatile memory (e.g., DRAM, SRAM, and SDRAM), a non-volatile memory (e.g., one time programmable ROM (OTPROM)), PROM, EPROM, EEPROM, mask ROM, flash ROM, and flash memory, a hard drive, and a solid state drive (SSD) by way of example. The external memory 234 may include flash drive such as compact flash (CF), secure digital (SD), Micro-SD, Mini-SD, extreme digital (xD), multimedia card (MMC), and memory stick. The external electronic device 234 may be functionally or physically connected with the electronic device 201 via various interfaces.

The sensor module 240 may measure physical quantities or detects an operation state of the electronic device 201 and convert the measured or detected information to an electrical signal. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, an illumination sensor 240K, and an ultraviolet (UV) sensor 240M. Additionally or alternatively, the sensor module 240 may include an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one sensor therein. According to an embodiment, the electronic device 201 may further include another processor configured to control the sensor module 240 as part of or separated from the processor 210, and the another processor may control the sensor module 240 while the processor 210 is in a sleep state.

The input device 250 may include a touch panel 252, a (digital) pen sensor 254, a key 256, or an ultrasonic input device 258 by way of example. The touch panel 252 may use at least one of capacitive, resistive, infrared, or ultrasonic methods by way of example. The touch panel 252 may further include a control circuit. The touch panel 252 may further include a tactile layer to provide tactile response to a user. The (digital) pen sensor 254 may include a sheet for recognition as part of a touch panel or a separate sheet for recognition. The key 256 may include a physical button, an optical key, or a keypad, by way of example. The ultrasonic input device 258 may detect ultrasonic waves generated by an input tool through a microphone (e.g., the microphone 288) and ascertain data corresponding to the detected ultrasonic waves.

The display 260 (e.g., the display 160) may include a panel 262, a hologram device 264, a projector 266, and a control circuit for controlling the aforementioned components. The panel 262 may be implemented to be flexible, transparent, or wearable. The panel 262 may include a touch panel 252 and at least one module. According to an embodiment, the panel 262 may include a pressure sensor (or force sensor) that measures the intensity of touch pressure by a user. The pressure sensor may be implemented integrally with the touch panel 252, or may be implemented as at least one sensor separately from the touch panel 252. The hologram device 264 may display a stereoscopic image in the air using a light interference phenomenon. The projector 266 may display an image by projecting light on a screen. The screen may be placed inside or outside the electronic device 201 by way of example. The interface 270 may include an HDMI 272, a USB 274, an optical interface 276, or a D-subminiature (D-sub) 278 by way of example. The interface 270 may be included in the communication interface 170 shown in FIG. 1 by way of example. Additionally or alternatively, the interface 270 may include a mobile high-definition link (MHL) interface, an SD card/MMC interface, or an infrared data association (IrDA) standard interface.

The audio module 280 may convert sounds into electrical signals and convert electrical signals into sounds. At least some components of the audio module 280 may be included in the input/output interface 145 shown in FIG. 1 by way of example. The audio module 280 may process sound information inputted/outputted through a speaker 282, a receiver 284, an earphone 286, or a microphone 288. The camera module 291, as a device for capturing a still image and a video image, may include at least one image sensor (e.g., a front sensor or a rear sensor), a lens, an image signal processor (ISP), or a flash (e.g., an LED or a xenon lamp). The power management module 295 may manage the power of the electronic device 201. The power management module 295 may include a power management IC (PMIC), a charger IC, or a battery or fuel gauge. The PMIC may support wired and/or wireless charging methods. Examples of the wireless charging method may include a magnetic resonance method, a magnetic induction method, and an electromagnetic method, and the PMIC may further include supplementary circuit such as a coil loop, a resonant circuit, and a rectifier. The battery gauge may measure a remaining capacity of the battery 296, charging voltage and current, and temperature of the battery by way of example. The battery 296 may include a rechargeable battery and/or a solar battery by way of example.

The indicator 297 may display a specific state of the electronic device 201 or part thereof (e.g., the processor 210), such as a booting state, a message state, or a charging state. The motor 298 may convert electrical signals into mechanical vibration and may generate vibration or haptic effect. The electronic device 201 may include a mobile TV-support device (e.g., a GPU) for processing media data generated in compliance with the standards such as digital multimedia broadcasting (DMB), digital video broadcasting (DVB), and mediaFlo™. Each of the above-mentioned components may be configured with at least one component and the name of a corresponding component may vary according to the type of an electronic device. According to various embodiments, the electronic device (e.g., electronic device 201) may be configured without part of the aforementioned components or with additional components; part of the components may be combined into one entity capable of executing the same functions of the components before being combined.

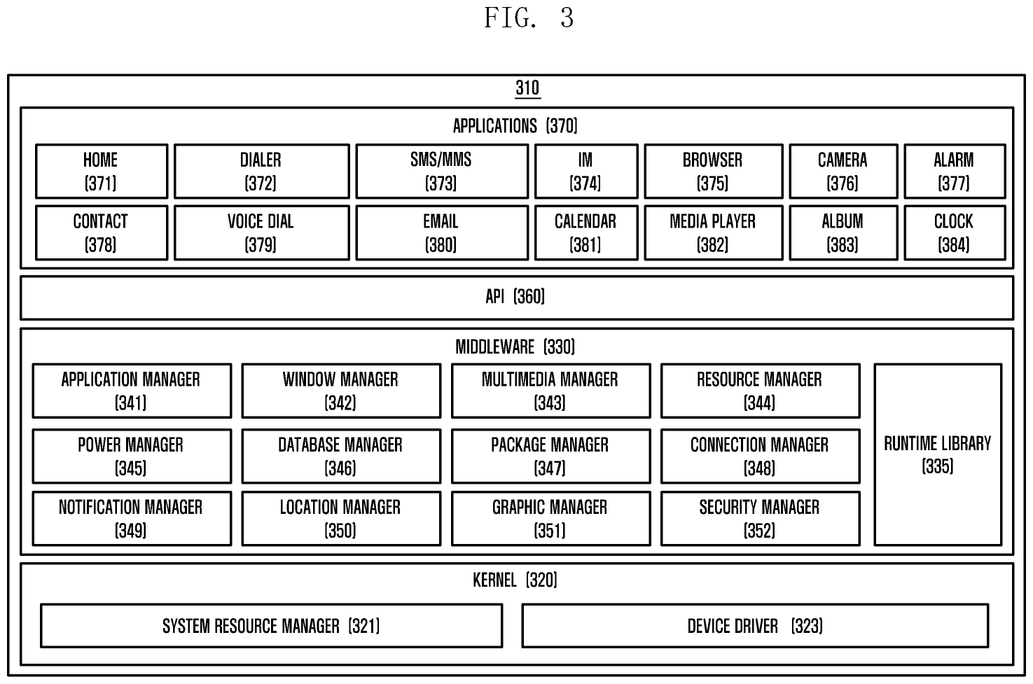

FIG. 3 is a block diagram illustrating a program module according various embodiments.

According to an embodiment, the program module 310 (e.g., program 140) may include an operating system for controlling the resources of the electronic device (e.g. electronic device 101) and various applications (e.g., application program 147) running on the operating system. The operating system may include Android™, iOS™, Windows™, Symbian™, Tizen™, and Bada™ for example. In reference to FIG. 3, the program module 310 may include a kennel 320 (e.g., kernel 141), a middleware 330 (e.g., middleware 143), an API 360 (e.g., API 145), and an application 370 (e.g., application 147). At least part of the program module 310 may be pre-loaded on the electronic device or downloaded from an external electronic device (e.g., electronic devices 102 and 104).

The kernel 320 may include a system resource manager 321 a device driver 323 by way of example. The system resource manager 321 may control, assign, or withdraw the system resources. According to an embodiment of the present disclosure, the system resource manager 321 may include a process manager, a memory manager, and a pile system manager. The device driver 323 may include a display driver, a camera driver, a Bluetooth driver, a common memory driver, a USB driver, a keypad driver, a Wi-Fi driver, an audio driver, and an inter-process communication (IPC) driver. The middleware 330 may provide a function for use by the applications in common and various functions for allowing the applications 370 to use the restricted system resources of the electronic device efficiently through the API 360. According to various embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module for use by a compiler to add new functions with a programming language while the applications 370 are in running. The runtime library 335 may perform input/output management, memory management, and arithmetic function processing. The application manager 341 may manage the life cycles of the applications 370 by way of example. The window manager 342 may manage the GUI resources in use for screens. The multimedia manager 343 may check the formats of media files to encode or decode the media files using the codecs proper to the corresponding formats. The resource manager 344 may manage source codes of the applications 370 and memory space. The power manager 345 may manage battery capacity and power by way of example and provide power information necessary for the operation of the electronic device. According to an embodiment, the power manager 345 may interoperate with a basic input/output system (BIOS). The database manager 346 may generate, search, and modify a database for use by the applications 370 by way of example. The package manager 347 may manage installation and update of application distributed in the form of a package file.

The connectivity manager 348 may manage a wireless connection by way of example. The notification manager 349 may provide the user with events such as incoming message alarm, appointment alarm, and proximity alarm by way of example. The location manager 350 may manage location information of the electronic device. The graphic manager 351 may manage graphical effects and user interfaces to be provided to user by way of example. The security manager 352 may responsible for system security and user authentication by way of example. According to an embodiment, the middleware 330 may include a telephony manager for managing voice and video call functions of the electronic device and a middleware module capable of combining the functions of the aforementioned components. According to an embodiment, the middleware 330 may provide operation system type-specific modules. The middleware 330 may delete part of the existing components or add new components dynamically. The API 360 may provide operating system type-specific API program functions sets by way of example. For example, it may be possible to a set of APIs per platform for the case of the android or iOS and two or more sets of APIs per platform for the case of the Tizen.

The applications 370 may include a home 371, a dialer 372, an SMS/MMS 373, an instant message (IN/I) 374, a browser 375, a camera 376, an alarm 377, a contact 378, a voice dial 379, an email 380, a calendar 381, a media player 382, an album 383, a watch 384, a health care (e.g., workout amount and blood sugar), environmental information provision application (e.g., atmospheric pressure, humidity, and temperature). According to an embodiment, the application 370 may include an information exchange application for supporting information exchange between the electronic device and an external electronic device. The information exchange application may include a notification relay application for relaying specific information to the external electronic device and a device management application for managing the external electronic device by way of example. The notification relay application may relay notification information generated by another application of the electronic device to the external electronic device or provide the user with the notification information received from the external electronic device. The device management application may manage the functions of the external electronic device (e.g., turn-on/off of the external electronic device in itself (or a component thereof) and brightness (or resolution) adjustment of the display) communicating with the electronic device and install, uninstall, or update the applications operating on the external electronic device by way of example. According to an embodiment, the application 370 may include an application (e.g., healthcare application of a mobile medical device) designated according to the property of the external electronic device. According to an embodiment, the applications 370 may include an application received from the external electronic device. At least part of the application module 310 may be implemented (e.g., executed) in the form of software, firmware, hardware, or a combination of at least two thereof and include a module, a program, a routine, a command set, or a process for performing at least one function.

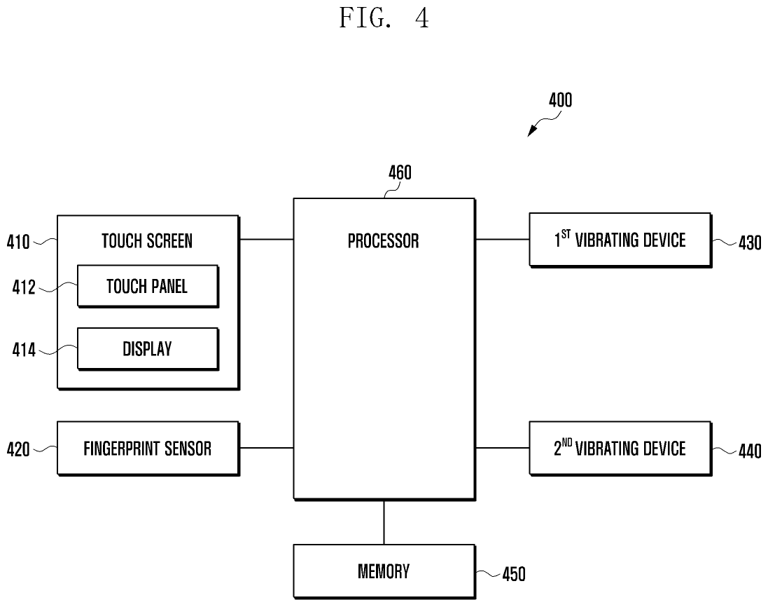

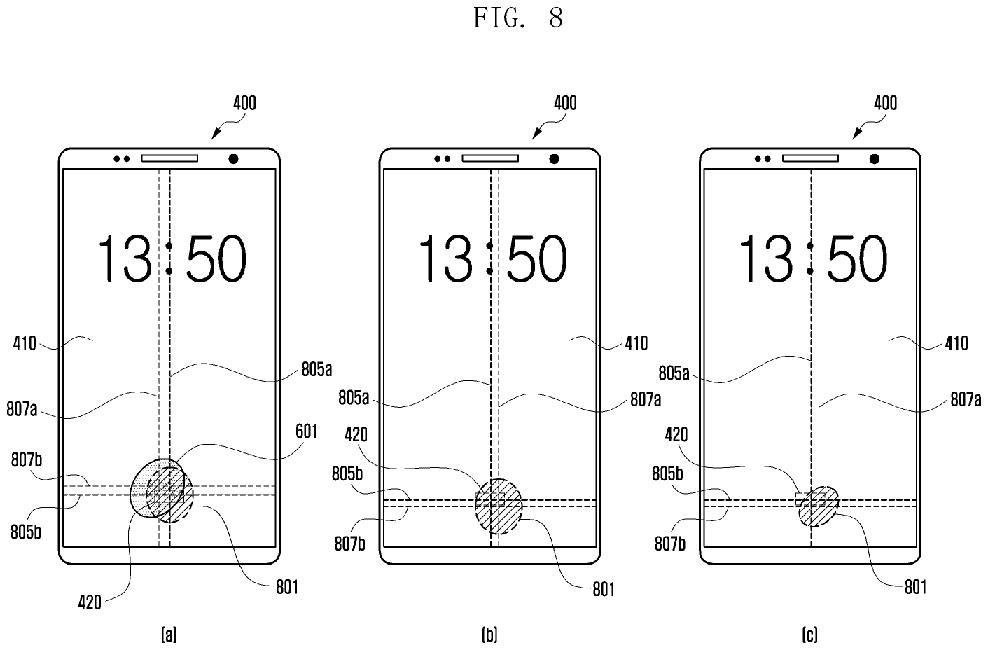

According to various embodiments, a method for displaying a graphical object for a fingerprint input may include, at a processor (e.g., a processor 460 in FIG. 4), displaying a graphical object (e.g., a user interface (UI) object 801 in FIG. 8) in a first area including at least partial area of a fingerprint sensor (e.g., a fingerprint sensor 420 in FIG. 4) through a display (e.g., a display 414 in FIG. 4); at the processor 460, acquiring a fingerprint input through the fingerprint sensor 420 and position information associated with the fingerprint input through a touch panel (e.g., a touch panel 412 in FIG. 4); and at the processor, displaying the graphical object in a second area including the at least partial area, at least based on the position information.

According to various embodiments, the method may further include, at the processor 460, when the fingerprint input satisfies a predetermined condition, based on fingerprint information and position information corresponding to the fingerprint information stored in a memory (e.g., a memory 450 in FIG. 4), storing fingerprint information corresponding to the fingerprint input and position information associated with the fingerprint input in the memory 450.

According to various embodiments, the method may further include, at the processor 460, performing a comparison between position information associated with the fingerprint input and position information corresponding to at least one piece of fingerprint information stored in a memory 450; and determining a position of the second area, at least based on a result of the comparison.

According to various embodiments, the method may further include, at the processor 460, performing a comparison between position information associated with the fingerprint input and position information corresponding to a plurality of pieces of fingerprint information stored in a memory 450; selecting at least one of the plurality of pieces of fingerprint information, at least based on a result of the comparison for the position information; performing a comparison between the selected at least one piece of fingerprint information and fingerprint information corresponding to the fingerprint input; and determining whether to perform authentication, at least based on a result of the comparison for the fingerprint information.

According to various embodiments, the method may further include, at the processor 460, identifying cumulative input information for a user's touch input through the touch panel 412; and determining a position of the first area or a position of the second area, at least based on the cumulative input information.

According to various embodiments, the method may further include, at the processor 460, controlling at least one vibrating device (e.g., a first vibrating device 430 in FIG. 4) corresponding to the first area to be operated with a first attribute; and controlling at least one vibrating device (e.g., a second vibrating device 440 in FIG. 4) corresponding to the second area to be operated with a second attribute.

According to various embodiments, the method may further include, at the processor 460, changing a size of the graphical object displayed in the second area including the at least partial area, at least based on the position information.

According to various embodiments, the method may further include, at the processor 460, performing a comparison between position information associated with the first area and position information associated with the fingerprint input, and determining a position of the second area, at least based on a result of the comparison.

According to various embodiments, the second area may be different from the first area.

The term “module” used in this disclosure may mean a unit including, for example, one or a combination of hardware, software, and firmware. The term “module” may be interchangeably used with other terms, for example, such as unit, logic, logical block, component, or circuit. The “module” may be the minimum unit, or a part thereof, of an integrally constructed component. The “module” may be the minimum unit, or a part thereof, for performing one or more functions. The “module” may be implemented mechanically or electronically. For example, according to the present disclosure, the “module” may include at least one of an application-specific integrated circuit (ASIC) chip, field-programmable gate arrays (FPGAs), and a programmable-logic device, which are known or to be developed later and perform particular functions.

According to various embodiments, at least a part of the device (e.g., modules or functions thereof) or the method (e.g., operations) may be implemented as instructions stored in a non-transitory computer-readable storage medium (e.g., the memory 130) in a programming module form. When the instructions are executed by a processor (e.g., 120), the processor may perform a function corresponding to the instructions. The non-transitory computer-readable recording medium may include magnetic media such as a hard disk, a floppy disk, and a magnetic tape, optical media such as a CD-ROM and a DVD, magneto-optical media such as a floptical disk, and hardware devices specially configured to store and perform a program instruction. In addition, the program instructions may include high class language codes, which can be executed in a computer by using an interpreter, as well as machine codes made by a compiler.

A computer-readable recording medium in which a program for controlling a function of an electronic device according to various embodiments of the disclosure is recorded may perform a method for displaying a graphical object (e.g., a user interface (UI) object 801 in FIG. 8) in a first area including an at least partial area of a fingerprint sensor (e.g., a fingerprint sensor 420 in FIG. 4) through a display (e.g., a display 414 in FIG. 4); acquiring a fingerprint input through the fingerprint sensor 420 and position information associated with the fingerprint input through a touch panel (e.g., a touch panel 412 in FIG. 4); and displaying the graphical object in a second area including the at least partial area, at least based on the position information.

A module or programming module according to various embodiments may include or exclude at least one of the above-discussed components or further include any other component. The operations performed by the module, programming module, or any other component according to various embodiments may be executed sequentially, in parallel, repeatedly, or by a heuristic method. Additionally, some operations may be executed in different orders or omitted, or any other operation may be added.

Embodiments disclosed herein are presented for the purpose of explanation and understanding of described technologies and do not limit the scope of the technologies. Accordingly, the scope of the disclosure should be interpreted to include all modifications or any other embodiment based on the technical idea of the disclosure.

FIG. 4 is a block diagram illustrating a configuration of an electronic device according to various embodiments of the disclosure.

Referring to FIG. 4, the electronic device 400 may include all or parts of the electronic device 101 shown in FIG. 1 or the electronic device 201 shown in FIG. 2.

The electronic device 400 (e.g., the electronic device 101, 102, or 201) according to various embodiments may include a touch screen 410, a fingerprint sensor 420 (e.g., the biometric sensor 240I), a first vibrating device 430, a second vibrating device 440, a memory 450 (e.g., the memory 130 or 230), and a processor 460 (e.g., the processor 120 or 210).

The touch screen 410 may display a user interface (UI) object (e.g., a graphical object) associated with user's fingerprint authentication in an at least partial area thereof. The touch screen 410 may include a fingerprint sensing area of the fingerprint sensor 420 in an at least partial area of or the entire area of a touch panel 412 (e.g., the touch panel 252) or a display 414 (e.g., the display 260). For example, the fingerprint sensing area may be disposed through printing or etching on a surface of a cover glass equipped over the display 414 for protection. The fingerprint sensing area may be disposed above or under the touch panel 412. The fingerprint sensing area may be disposed within pixels of the touch panel 412 or in a black masking area between such pixels. According to an embodiment, the touch panel 412 may be configured as a separate layer from the display 414, or may be arranged as an in-cell structure in the display 414.

According to an embodiment, the touch screen 410 may acquire touch information (e.g., touch coordinates, a touch direction, a touch angle, etc.) associated with fingerprint authentication of a user of the electronic device 400 through the touch panel 412 and transmit the acquired touch information to the processor 460. Under the control of the processor 460, the touch screen 410 may displays the UI object in a first or second area including an at least partial area of the fingerprint sensor 420 via the display 414 in connection with the fingerprint sensing area.

According to various embodiments, the touch screen 410 may perform both an input function and a display function. To do this, the touch screen 410 may include the touch panel 412 and the display 414. The touch panel 412 may be formed of a touch sensor of a capacitive overlay type, a resistive overlay type, or an infrared beam type, or may be formed of a pressure sensor. Alternatively, any other type sensor capable of sensing contact or pressure of a thing may be used for the touch panel 412. The touch panel 412 may sense a user' touch input, generate a sensing signal, and transmit the sensing signal to the processor 460. The sensing signal may contain touch coordinate information, touch direction information, touch angle information, and the like regarding the user's touch input. When the user's touch input has a drag action of a touch position, the touch panel 412 may generate a sensing signal containing coordinate information and direction information regarding a touch-and-drag path and transmit the sensing signal to the processor 460. The display 414 may be formed of a liquid crystal display (LCD), an organic light emitting diode (OLED), an active matrix organic light emitting diode (AMOLED), or the like. The display 414 may visually offer, to the user, a menu of the electronic device 400, input data, function setting information, and various kinds of information.

The fingerprint sensor 420 may acquire fingerprint information of the user of the electronic device 400. The fingerprint sensor 420 may be disposed to cover an at least partial area of or the entire area of the touch screen 410. The fingerprint sensor 420 is capable of acquiring the fingerprint information of the user as soon as the user performs a touch input on the touch screen 410. The fingerprint sensor 410 may be one or more (i.e., 1, 2, . . . , n). The fingerprint information acquired through the fingerprint sensor 420 may be stored as image information and compared with user's fingerprint information already stored in the memory 450 to authenticate the user of the electronic device 400. The fingerprint information acquired through the fingerprint sensor 420 may be stored in a compressed form of a fingerprint image. The fingerprint sensor 420 may extract only features of a fingerprint image, convert the extracted features into a non-restorable form of the original fingerprint image, and store the converted features in the memory 450. The fingerprint information acquired through the fingerprint sensor 420 may be stored in the memory 450 in a binary or natural number form. The fingerprint information extracted through the fingerprint sensor 420 may be stored in the memory 450 as a single feature template.

According to an embodiment, the fingerprint sensor 420 may provide at least one fingerprint sensing scheme. For example, the fingerprint sensor 420 may acquire fingerprint information corresponding to a user's fingerprint, based on the amount of current changed when a user's finger touches at least a portion of a fingerprint sensing area. The fingerprint sensing area of the fingerprint sensor 410 may be disposed in an at least partial area of or the entire area of the touch screen 410, a keyboard, a button, or an icon of the electronic device 400. The fingerprint sensor 420 may include a fingerprint sensing array divided into a plurality of regions.

According to various embodiments, the fingerprint sensor 420 may acquire user's fingerprint information by using at least one technique of optical type, capacitive type, ultrasonic type, and IR type. In case of the optical type, it is possible to acquire user's fingerprint information by capturing a fingerprint image through a photosensitive diode. In case of the capacitive type, it is possible to acquire fingerprint information by using the principle that ridges of a fingerprint touched to an electrode are detected and non-touched grooves between the ridges are not detected. In case of the ultrasonic type, it is possible to acquire fingerprint information by generating ultrasonic waves at a piezoelectric device and then detecting a path difference between the ultrasonic waves reflected on the fingerprint ridges and those reflected on the fingerprint grooves.

The first vibrating device 430 may generate a vibration at a first position (e.g., a left portion) of the fingerprint sensor 420. The second vibrating device 440 may generate a vibration at a second position (e.g., a right portion) of the fingerprint sensor 420. The first and second vibrating devices 430 and 440 may have the same or different vibration frequencies and vibration intensities. Each of the first and second vibrating devices 430 and 440 may include a motor (e.g., the motor 298 in FIG. 2) that converts an electric signal into a mechanical motion and thereby generate a vibration or a haptic effect. According to various embodiments, in addition to the and second vibrating devices 430 and 440, any other vibrating device may be further included.

The memory 450 may store fingerprint information of the user of the electronic device 400. The memory 430 may store resources about various UI objects (e.g., graphical objects) associated with the fingerprint sensor 410. The resources about the UI objects may be loaded in a framework and displayed on the display 414. The memory 450 may store various programs and data related to a fingerprint recognition or touch function, based on the touch panel 412 or the fingerprint sensor 420 of the electronic device 400. For example, the memory 440 may store a program for processing a function of the fingerprint sensor 420 to acquire fingerprint information through at least one scanning scheme and also store data processed according to the program. The memory 450 may store in advance user's fingerprint information, which may be used to confirm whether fingerprint information to be recognized later through the fingerprint sensor 420 is identical or not.

According to an embodiment, the memory may store touch information (e.g., touch coordinates, a touch direction, a touch angle, etc.) acquired through the touch panel 412 and fingerprint information acquired through the fingerprint sensor 420. The memory 450 may store instructions to change a display position of a UI object, based on the touch information, and then display the position-changed UI object. The memory 450 may store instructions to offer a vibration (e.g., tactile feedback) corresponding to the position of the UI object, based on the touch information. The memory 450 may store instructions to set the display position of the UI object for acquiring a fingerprint of the user of the electronic device 400, based on a user's previous touch position on an object (e.g., keyboard, button, icon, etc.). The memory 450 may store at least one piece of fingerprint information acquired through the fingerprint sensor 420 and position information (e.g., touch input coordinates) corresponding to the at least one piece of fingerprint information.

According to various embodiments, the memory 450 may store a program for processing and controlling operations of the processor 460, an operating system (OS), various applications, input/output data, and a program for controlling the overall operation of the electronic device 400. The memory 450 may store a user interface (UI) provided in the electronic device 400 and various kinds of setting information necessary for performing functions in the electronic device 400.

The processor 460 is capable of controlling the functions and operations of the touch screen 410, the fingerprint sensor 420, the first vibrating device 430, the second vibrating device 440, and the memory 450 in the electronic device 400. The processor 460 may execute applications stored in the memory 450. For example, one of such applications may be an application having a fingerprint recognition function related to financial settlement, security, personal contents, login, etc., and providing a UI object (e.g., a fingerprint authentication indication) associated with the fingerprint recognition function.

According to an embodiment, the processor 460 may be configured to display a UI object (e.g., a graphical object) in a first area including an at least partial area of the fingerprint sensor 420 through the display 414, to acquire a fingerprint input through the fingerprint sensor 420 and position information (e.g., touch input coordinates) associated with the fingerprint input through the touch panel 414, and to display the graphical object in a second area including the at least partial area of the fingerprint sensor 420, at least based on the position information.

According to an embodiment, the processor 460 may be configured to, when the fingerprint input satisfies a predetermined condition, store fingerprint information corresponding to the fingerprint input and position information (e.g., touch input coordinates) associated with the fingerprint input in the memory 450.

According to an embodiment, the processor 460 may be configured to perform a comparison between position information (e.g., touch input coordinates) associated with the fingerprint input and position information corresponding to at least one piece of fingerprint information stored in the memory 450, and to determine a position of the second area, at least based on a result of the comparison.

According to an embodiment, the processor 460 may be configured to perform a comparison between position information (e.g., touch input coordinates) associated with the fingerprint input and position information corresponding to a plurality of pieces of fingerprint information stored in the memory 450, to select at least one of the plurality of pieces of fingerprint information, at least based on a result of the comparison for the position information, to perform a comparison between the selected at least one piece of fingerprint information and fingerprint information corresponding to the fingerprint input, and to determine whether to perform authentication, at least based on a result of the comparison for the fingerprint information.

According to an embodiment, the processor 460 may be configured to identify cumulative input information for a user's touch input through the touch panel 412, and to determine the position of the first area or the position of the second area, at least based on the cumulative input information.

According to an embodiment, the processor 460 may be configured to control at least one vibrating device corresponding to the first area among a plurality of vibrating devices (e.g., the first vibrating device 430 and the second vibrating device 440) to be operated with a first attribute (e.g., vibration frequency and vibration intensity), and to control at least one vibrating device corresponding to the second area among the plurality of vibrating devices to be operated with a second attribute (e.g., vibration frequency and vibration intensity). The vibration frequencies of the first and second attributes may be the same or different.

According to an embodiment, the processor 460 may be configured to change a size of the graphical object displayed in the second area including the at least partial area, at least based on the position information.

According to an embodiment, processor 460 may be configured to perform a comparison between position information associated with the first area and position information (e.g., touch input coordinates) associated with the fingerprint input, and to determine a position of the second area, at least based on a result of the comparison.

According to various embodiments, the processor 460 may control the overall operation of the electronic device 400, control a signal flow between internal components of the electronic device 400, and perform a data processing function. The processor 460 may be composed of, for example, a central processing unit (CPU), an application processor, and a communication processor. The processor 440 may be formed of a single core processor or a multi-core processor, and may be composed of a plurality of processors.

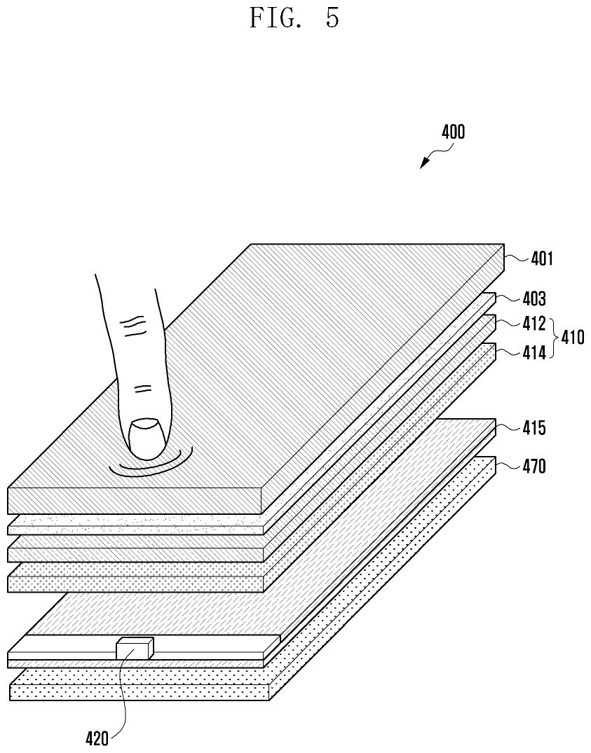

FIG. 5 is a schematic diagram illustrating a partial configuration of an electronic device according to various embodiments of the disclosure.

Referring to FIG. 5, the electronic device 400 according to various embodiments may include a cover window 401, the touch screen 410 including the touch panel 412 and the display 414, a printed board assembly (PBA) 415, the fingerprint sensor 420, and a housing 470.

In FIG. 5, the upward direction may be the front direction of the electronic device 400, and the downward direction may be the back direction of the electronic device 400. The cover window 401, the touch screen 410 including the touch panel 412 and the display 414, and the PBA 415 may be sequentially disposed in the housing 470.

The cover window 401 may be disposed on the front surface of the electronic device 400. The cover window 401 is provided to protect the touch screen 410 and the fingerprint sensor 420 from external impact, and may be formed of a transparent material. The cover window 401 may permit penetration of light generated inside the electronic device 400 to the outside. Also, the cover window 401 may permit penetration of incident light from the outside of the electronic device 400 into the electronic device 400.

According to an embodiment, the fingerprint sensor 420 may be disposed centrally on a lower portion of the PBA 415. The fingerprint sensor 420 may be disposed to cover a partial area or the entire area of the touch screen 410.

According to an embodiment, the touch panel 412 and the display 414 of the touch screen 410 may be disposed under the cover window 401. The cover window 401 and the touch panel 412 may be adhered to each other through an optically clear adhesive (OCA) 403.

According to an embodiment, the PBA 415 is provided to mount a processor (e.g., the processor 460 in FIG. 4), a memory (e.g., the memory 450 in FIG. 4), a communication interface (e.g., the communication interface 170 in FIG. 1), and the fingerprint sensor 420 (or various sensors such as the sensor module 240 in FIG. 2), which are required for the operation of the electronic device 400, and may be formed of a PCB or FPCB having terminals.

According to an embodiment, a battery (not shown) may be provided between the PBA 415 and the housing 470 to supply power necessary for operating the electronic device 400.

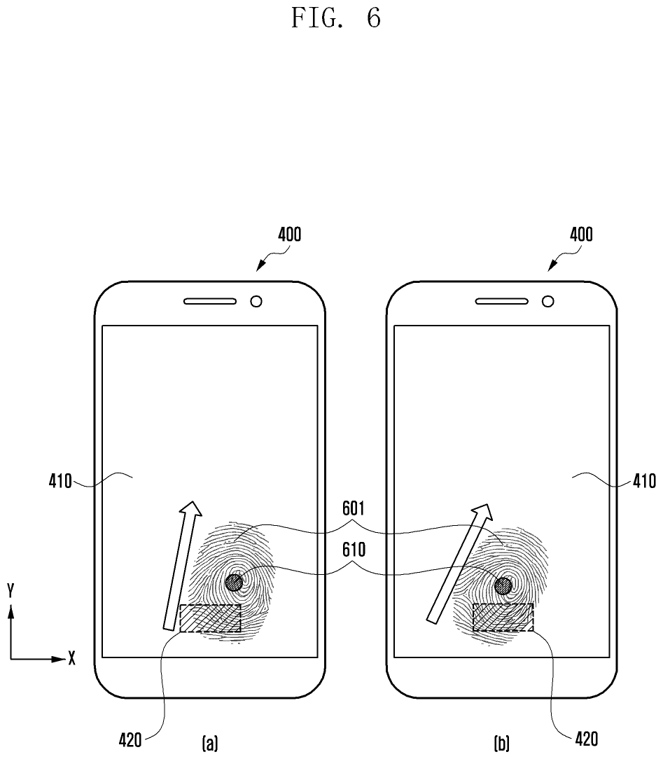

FIG. 6 is a diagram illustrating an example of acquiring touch information at an electronic device according to various embodiments of the disclosure.

Referring to FIG. 6, the electronic device 400 is capable of recognizing a user's fingerprint 601 through the touch screen 410 and the fingerprint sensor 420. When the user touches an area where the fingerprint sensor 420 is formed, the electronic device 400 acquires touch information that includes touch coordinates (e.g., X1, Y1) and/or touch direction (or touch angle) of the fingerprint 601 with respect to a touch point 610 on the touch screen 410 around the fingerprint sensor 420.

In FIG. 6, one example (a) shows that the fingerprint 601 with respect to the touch point 610 around the fingerprint sensor 420 of the electronic device 400 has touch coordinates of X=110 and Y=110 and a touch direction of 80 degrees.

In FIG. 6, another example (b) shows that the fingerprint 601 with respect to the touch point 610 around the fingerprint sensor 420 of the electronic device 400 has touch coordinates of X=100 and Y=110 and a touch direction of 70 degrees.

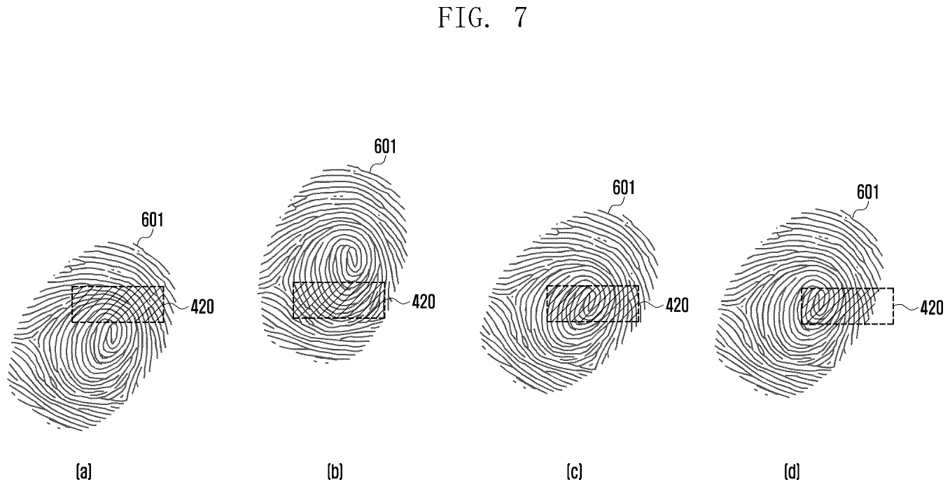

FIG. 7 is a diagram illustrating an example of acquiring touch information at an electronic device and then determining a candidate group of fingerprint information stored in a memory at fingerprint registration according to various embodiments of the disclosure.

In FIG. 7, a first example (a) shows that the fingerprint 601 of the user of the electronic device 400 is registered as touch coordinates of X=70 and Y=80 and a touch direction of 70 degrees with respect to a template of fingerprint information stored in the memory 450.

In FIG. 7, a second example (b) shows that the fingerprint 601 of the user of the electronic device 400 is registered as touch coordinates of X=110 and Y=120 and a touch direction of 80 degrees with respect to a template of fingerprint information stored in the memory 450.

In FIG. 7, a third example (c) shows that the fingerprint 601 of the user of the electronic device 400 is registered as touch coordinates of X=100 and Y=105 and a touch direction of 60 degrees with respect to a template of fingerprint information stored in the memory 450.

Meanwhile, in FIG. 7, a fourth example (d) shows that the user of the electronic device 400 inputs the fingerprint 601 through the touch screen 410 and the fingerprint sensor 420. This fingerprint input has touch coordinates of X=100 and Y=95 and a touch direction of 60 degrees.

In this case, the processor 460 of the electronic device 400 may perform a matching algorithm first with fingerprint information of the third example (c) which is most similar to touch information that contains touch coordinates of X=100 and Y=95 and a touch direction of 60 degrees.

FIG. 8 is a diagram illustrating an example of changing a position of a user interface (UI) object for acquiring fingerprint information in case of a failure of fingerprint authentication at an electronic device according to various embodiments of the disclosure.

Referring to FIG. 8, when failing to authenticate a user's fingerprint, the electronic device 400 according to various embodiments of the disclosure may change a UI object 801 for acquiring a fingerprint 601 from a first position (e.g., a position of a first area) to a second position (e.g., a position of a second area), based on user's touch information (e.g., touch coordinates, a touch direction, or a touch angle) on the touch screen 410 and the fingerprint sensor 420. The UI object 801 (e.g., a graphical object) may be a fingerprint authentication indication that guides the user to a touch position of the fingerprint 601.

According to an embodiment, the first position (e.g., the position of the first area) of the UI object 801 may be a cross point between a thick dotted vertical line 805a and a thick dotted horizontal line 805b as shown in part (a) of FIG. 8. The second position (e.g., the position of the second area) of the UI object 801 may be a cross point between a thin dotted vertical line 807a and a thin dotted horizontal line 807b as shown in part (b) of FIG. 8. The first and second positions of the UI object 801 may correspond to at least a portion of the fingerprint sensing area of the fingerprint sensor 420.

Referring to part (a) of FIG. 8, the UI object 801 of the electronic device 400 according to various embodiments may be displayed around the fingerprint sensor 420. For example, the UI object 801 may be displayed around the cross point between the thick dotted vertical line 805a and the thick dotted horizontal line 805b as shown in part (a) of FIG. 8. For example, the cross point between the thick dotted vertical line 805a and the thick dotted horizontal line 805b may correspond to central coordinates of the fingerprint sensor 420. For example, the cross point between the thin dotted vertical line 807a and the thin dotted horizontal line 807b as shown in part (b) of FIG. 8 may correspond to central coordinates of the UI object 801.

According to an embodiment, the UI object 801 may include at least one of a letter, a number, an icon, a button, and an image. The electronic device 400 may have a sensing area for detecting a touch action on the UI object 801. The UI object 801 may correspond to the sensing area.

Referring to parts (a) to (c) of FIG. 8, in an embodiment, when the fingerprint 601 touched by the user deviates, at least in part, from the UI object 801 and thereby causes a failure of fingerprint authentication, the processor 460 of the electronic device 400 may change the position or size of the UI object 801 in consideration of such deviation, based on fingerprint position information acquired at the time of fingerprint registration.

For example, as shown in part (a) of FIG. 8, the UI object 801 may be displayed around the central point (e.g., the cross point between the thick dotted vertical line 805a and the thick dotted horizontal line 805b) of the fingerprint sensor 420. The user may touch the fingerprint 601 on a certain position (e.g., the cross point between the thin dotted vertical line 807a and the thin dotted horizontal line 807b) in an upper left direction from the UI object 801. In this case, as shown in part (b) of FIG. 8, the processor 460 of the electronic device 400 may change the position of the UI object 801 from the first position (e.g., the cross point between the thick dotted vertical line 805a and the thick dotted horizontal line 805b as shown in part (a) of FIG. 8) to the second position (e.g., the cross point between the thin dotted vertical line 807a and the thin dotted horizontal line 807b as shown in part (b) of FIG. 8). Also, as shown in part (c) of FIG. 8, the processor 460 may change the size or shape of the UI object 801 so that the user can touch the fingerprint 601 more exactly on the UI object 801. According to an embodiment, when the fingerprint 601 touched by the user deviates, at least in part, from the UI object 801 and thereby causes a failure of fingerprint authentication, the processor 460 of the electronic device 400 may change the position or size of the UI object 801 in consideration of such deviation, based on user's touch information (e.g., touch coordinates, a touch direction, or a touch angle) with respect to the touch screen 410 and position information of the fingerprint sensing area of the fingerprint sensor 420.

According to an embodiment, when a failure of fingerprint authentication occurs in a matching algorithm for authentication of a user's fingerprint, the electronic device 400 may change the position of the UI object 801 for acquiring the user's fingerprint, based on fingerprint touch information (e.g., touch coordinates, a touch direction, or a touch angle) having the highest degree of similarity or fingerprint position information of a fingerprint image having the highest degree of similarity. For example, when a fingerprint of the user of the electronic device 400 registered and stored in the memory 450 has touch coordinates of X=100 and Y=100 and a touch direction of 90 degrees, and when the user's fingerprint 601 entered for fingerprint authentication has touch coordinates of X=90 and Y=105 and a touch direction of 60 degrees, the processor 440 may change the position of the UI object 801 to a position corresponding to the touch information (touch coordinates of X=90 and Y=105 and a touch direction of 60 degrees) entered for fingerprint authentication.

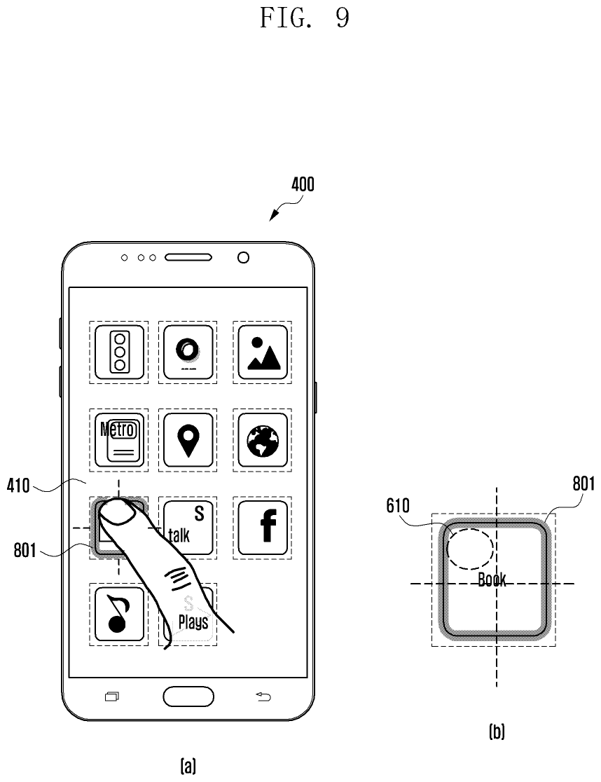

FIG. 9 is a diagram illustrating an example of identifying a touch pattern of a user's touch action on a sensing area of a user interface (UI) object at an electronic device according to various embodiments of the disclosure.

Referring to FIG. 9, when a user's touch action is made at a touch point 610 on the UI object 801, the electronic device 400 according to various embodiments may identify a touch pattern on the sensing area of the UI object 801. For the touch pattern with respect to the UI object 801 may include at least one of a touch area, a touch pressure, a position of the touch point 610, a touch form, and capacitance strength.

According to an embodiment, based on the identified touch pattern, the processor 460 of the electronic device 400 may change the position of the UI object 801 from the first position (e.g., the position of the first area) to the second position (e.g., the position of the second area). Also, based on the identified touch pattern, the processor 460 of the electronic device 400 may change the size of the UI object 801.

According to an embodiment, when a user's touch action is made in the sensing area of the UI object 801, the processor 460 of the electronic device 400 may store a history of the user's touch action in the memory 450. Then, based on the stored touch action history, the processor 460 may change the position of the UI object 801 associated with the fingerprint sensor 420 from the first position to the second position. The touch action history may include at least one of touch coordinates, a touch area, a touch direction, or a touch pressure of the user's touch action made for a specific one of a plurality of UI objects 801.

According to an embodiment, the processor 460 of the electronic device 400 may determine the first position (e.g., the position of the first area) of the UI object 801, based on the history stored in the memory 450. For example, when the fingerprint sensor 420 is in a standby state to receive a fingerprint input (e.g. the fingerprint 601 in FIG. 7) for security authentication, the UI object 801 may be displayed to the user. The UI object 801 may be displayed around the central coordinates (e.g., the cross point between the thick dotted vertical line 805a and the thick dotted horizontal line 805b as shown in part (a) of FIG. 8) of the fingerprint sensor 420. On the other hand, based on the touch action history stored in the memory 450, the processor 460 of the electronic device 400 may change the position of the UI object 801 from the first position (e.g., the position of the first area) to the second position (e.g., the position of the second area) in consideration of frequencies of fingerprint input patterns (e.g., fingerprint touch coordinates shown in FIG. 7).

According to an embodiment, when a user's touch action is made, the processor 460 of the electronic device 400 may change the position of the UI object 801 associated with the fingerprint sensor 420 by using the touch coordinates of the touch point 610 on the UI object 801. For example, the processor 460 may determine a relevance of the touch coordinates with respect to the central point of the UI object 801.

According to an embodiment, based on the touch action history stored in the memory 450, the processor 460 of the electronic device 400 may change the position of the UI object 801 associated with the fingerprint sensor 420 from the first position to the second position. For example, when the coordinates of the central point of the UI object 801 are X=100 and Y=100 in default, and when the coordinates of the touch point 610 by repeated touch inputs are X=95 and Y=105, the processor 460 may change the position of the UI object 801 associated with the fingerprint sensor 420 by X=−5 and Y=+5 from the default position.

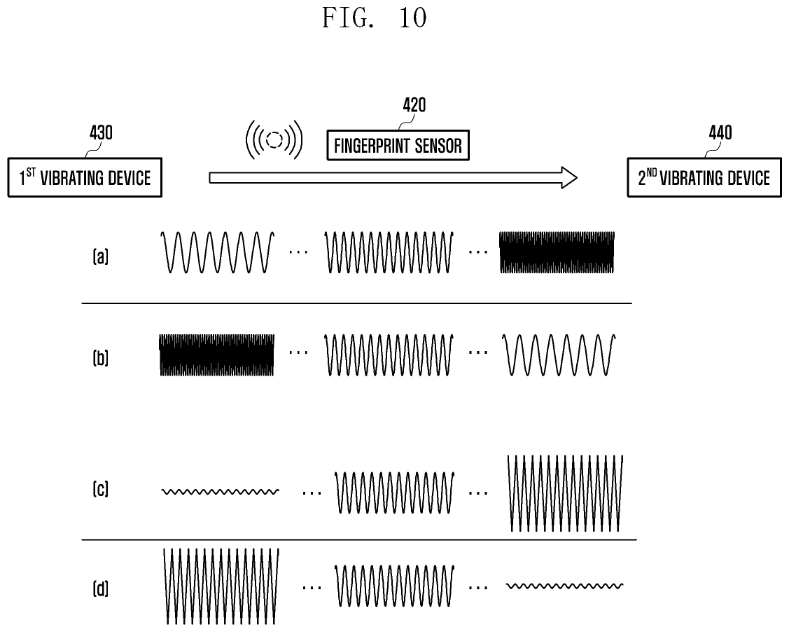

FIG. 10 is a diagram illustrating an example of indicating a position of a fingerprint sensor through at least one vibrating device at an electronic device according to various embodiments of the disclosure.

Referring to FIG. 10, based on the user's touch information (e.g., touch coordinates, a touch direction, or a touch angle), the electronic device 400 according to various embodiments may indicate the position (or direction) of the fingerprint sensor 420 in a tactile manner (e.g., vibration feedback) through the first vibrating device 430 or the second vibrating device 440. For example, based on both fingerprint position information acquired in a fingerprint registration process and fingerprint position information acquired in a fingerprint authentication process, the electronic device 400 may indicate the direction of the fingerprint sensor 420 to the user by using the first vibrating device 430 or the second vibrating device 440.

According to an embodiment, based on both touch position information acquired from a user's fingerprint input and position information of the fingerprint sensing area of the fingerprint sensor 420, the electronic device 400 may provide the user with a directional feedback (e.g., vibration) regarding the position of the fingerprint sensor 420 by using the first vibrating device 430 or the second vibrating device 440.

According to an embodiment, the first vibrating device 430 of the electronic device 400 may generate a vibration at the first position (e.g., the left side) of the fingerprint sensor 420. In addition, the second vibrating device 440 may generate a vibration at the second position (e.g., the right side) of the fingerprint sensor 420. The first and second vibrating devices 430 and 440 may have the same or different vibration frequencies and also have the same or different vibration intensities.

According to an embodiment, when a failure of fingerprint authentication occurs in a matching algorithm for authentication of a user's fingerprint wherein the coordinates of a user's touch on the fingerprint sensor 420 are X=100 and Y=100 and the coordinates of fingerprint information having higher similarity is X=100 and Y=110, the electronic device 400 may provide vibrations to guide the touch position for the fingerprint sensor 420 to the second position (e.g., to the right). For example, such vibrations may be provided through both the first and second vibrating devices 430 and 440. In addition, the vibration of the first vibrating device 430 and the vibration of the second vibrating device 440 may be different from each other to provide a directional vibration feedback.

According to an embodiment, the processor 460 of the electronic device 400 may control the first vibrating device 430, which corresponds to the first area (e.g., the left side) of the fingerprint sensor 420, to be operated with the first attribute (e.g., vibration frequency and vibration intensity). In addition, the processor 460 of the electronic device 400 may control the second vibrating device 440, which corresponds to the second area (e.g., the right side) of the fingerprint sensor 420, to be operated with the second attribute (e.g., vibration frequency and vibration intensity). According to an embodiment, the processor 460 of the electronic device 400 may include a vibration delivery processor that controls the first vibrating device 430 and the second vibrating device 440.

Referring to part (a) of FIG. 10, when a touch point (e.g., the touch point 610 in FIG. 9) on the UI object 801 corresponding to the fingerprint sensor 420 is closer to the first vibrating device 430 than the second vibrating device 440, the processor 460 of the electronic device 400 may control the second vibrating device 440 to vibrate more frequently than the first vibrating device 430. This allows the user to recognize that the central point of the fingerprint sensor 420 for fingerprint authentication is positioned toward the second vibrating device 440.

Referring to part (b) of FIG. 10, when a touch point (e.g., the touch point 610 in FIG. 9) on the UI object 801 corresponding to the fingerprint sensor 420 is closer to the second vibrating device 440 than the first vibrating device 430, the processor 460 of the electronic device 400 may control the first vibrating device 430 to vibrate more frequently than the second vibrating device 440. This allows the user to recognize that the central point of the fingerprint sensor 420 for fingerprint authentication is positioned toward the first vibrating device 430.

According to an embodiment, when a user's touch point (e.g., the touch point 610 in FIG. 9) on the UI object 801 is almost identical to the central point of the fingerprint sensor 420, the processor 460 of the electronic device 400 may control the first and second vibrating devices 430 and 440 to have the same number of vibrations (e.g., vibration frequency).

Referring to part (c) of FIG. 10, when a touch point (e.g., the touch point 610 in FIG. 9) on the UI object 801 corresponding to the fingerprint sensor 420 is closer to the first vibrating device 430 than the second vibrating device 440, the processor 460 of the electronic device 400 may control the second vibrating device 440 to vibrate at higher intensity than the first vibrating device 430. This allows the user to recognize that the central point of the fingerprint sensor 420 for fingerprint authentication is positioned toward the second vibrating device 440.

Referring to part (d) of FIG. 10, when a touch point (e.g., the touch point 610 in FIG. 9) on the UI object 801 corresponding to the fingerprint sensor 420 is closer to the second vibrating device 440 than the first vibrating device 430, the processor 460 of the electronic device 400 may control the first vibrating device 430 to vibrate at higher intensity than the second vibrating device 440. This allows the user to recognize that the central point of the fingerprint sensor 420 for fingerprint authentication is positioned toward the first vibrating device 430.

According to an embodiment, when a user's touch point (e.g., the touch point 610 in FIG. 9) on the UI object 801 is almost identical to the central point of the fingerprint sensor 420, the processor 460 of the electronic device 400 may control the first and second vibrating devices 430 and 440 to have the same vibration intensity.

According to an embodiment, the processor 460 of the electronic device 400 may provide fingerprint sensor position information to the user in a different manner depending on whether the user releases a touch for fingerprint authentication. For example, when a user's touch for fingerprint authentication is not released, the processor 460 may provide the position information of the fingerprint sensor 420 to the user through a plurality of vibrating devices (e.g., the first vibrating device 430 and the second vibrating device 440). In addition, when user. For example, when a user's touch for fingerprint authentication is released, the processor 460 may provide the position information of the fingerprint sensor 420 to the user by changing the position of the UI object (e.g., the UI object 801) to meet the sensing area of the fingerprint sensor 420.

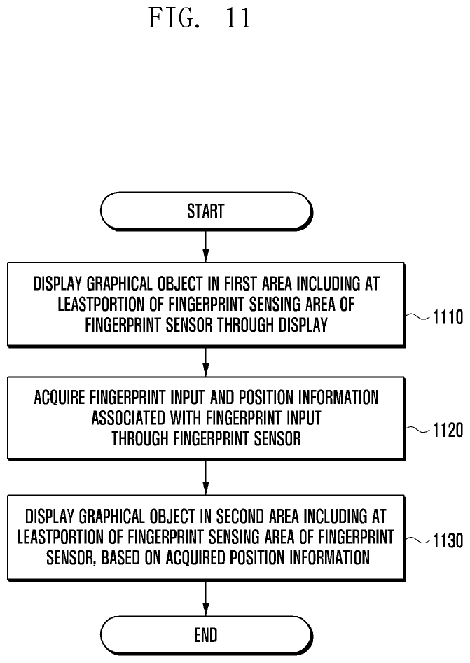

FIG. 11 is a flow diagram illustrating a method for displaying a user interface (UI) object (e.g., a graphical object) for a fingerprint input at an electronic device according to various embodiments of the disclosure.

At operation 1110, the processor 460 may display, through the display 414 of the touch screen 410, a UI object such as a graphical object (e.g., the UI object 801 in FIG. 8) in a first area that includes at least a portion of the fingerprint sensing area of the fingerprint sensor 420. For example, the UI object 801 may include at least one of a letter, a number, an icon, a button, and an image.

At operation 1120, the processor 460 may receive an input of a user's fingerprint (e.g., the fingerprint 601 in FIG. 7) through the fingerprint sensor 420 and then acquire position information (e.g., touch input coordinates) associated with the input of the fingerprint 601 through the touch panel 414.

At operation 1130, the processor 460 may display the graphical object in a second area that includes at least a portion of the fingerprint sensing area of the fingerprint sensor 420, at least based on the acquired position information.

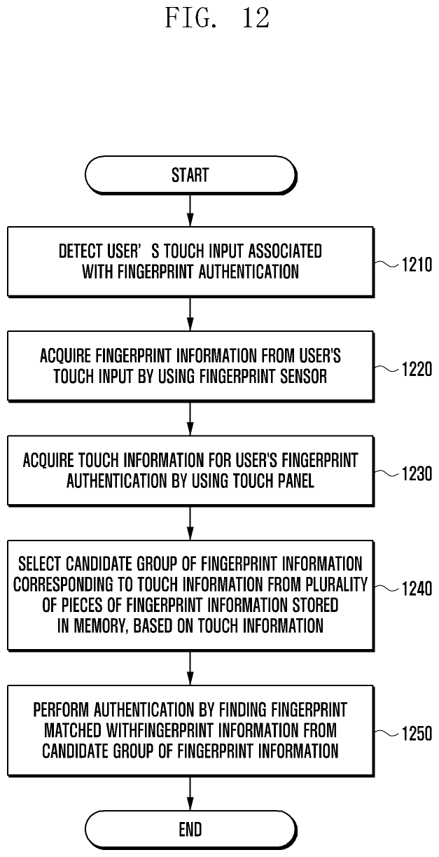

FIG. 12 is a flow diagram illustrating a method for performing fingerprint authentication of a user through fingerprint information and touch information at an electronic device according to various embodiments of the disclosure.

At operation 1210, the processor 460 may detect a user's touch input associated with fingerprint authentication through the touch screen 410 having the fingerprint sensor 420 therein.

At operation 1220, the processor 460 may acquire user's fingerprint information from the user's touch input by using the fingerprint sensor 420.

At operation 1230, the processor 460 may acquire touch information for user's fingerprint authentication by using the touch panel 412 of the touch screen 410.

According to an embodiment, when the user touches the UI object 801 corresponding to the sensing area of the fingerprint sensor 420, the processor 460 of the electronic device 400 may acquire touch information including touch coordinates (e.g., X1, Y1) and a touch direction (or touch angle) of a fingerprint (e.g., the fingerprint 601 in FIG. 6) at a touch point (e.g., the touch point 610 in FIG. 6) of the touch screen 410.

At operation 1240, the processor 460 may select a candidate group of fingerprint information corresponding to the acquired touch information from among a plurality of pieces of user's fingerprint information stored in the memory 450.

At operation 1250, the processor 460 may find a fingerprint matched with the acquired fingerprint information from among the selected candidate group of fingerprint information through comparison and then perform authentication through the matched fingerprint.

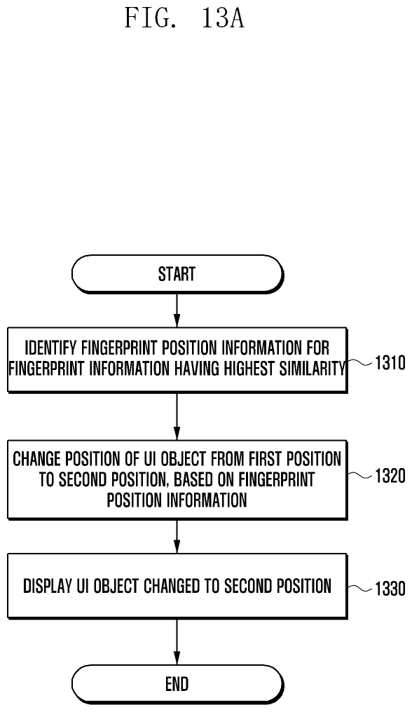

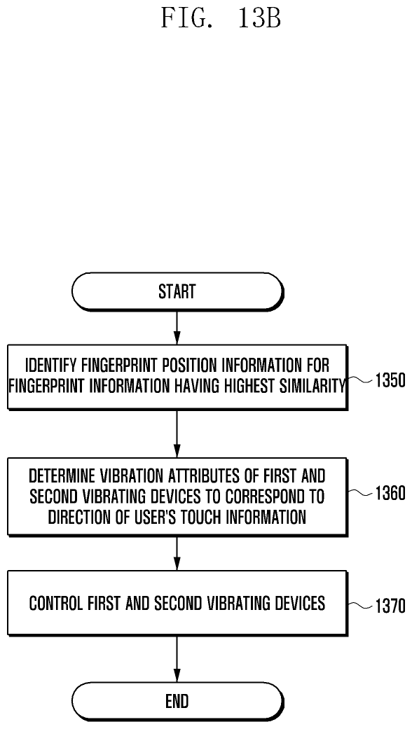

FIG. 13A is a flow diagram illustrating a method for changing and displaying a user interface (UI) object to acquire fingerprint information of a user in case of a failure of fingerprint authentication at an electronic device according to various embodiments of the disclosure.

Referring to FIG. 13A, when user's fingerprint authentication fails, the electronic device 400 according to various embodiments may display a changed UI object and then acquire again user's fingerprint information.

When user's fingerprint authentication fails, at operation 1310 the processor 460 may identify, from a plurality of pieces of user fingerprint registration information stored in the memory 450, fingerprint position information for fingerprint touch information having the highest similarity with fingerprint information for fingerprint authentication.

At operation 1320, based on the fingerprint position information, the processor 460 may change the position of the UI object (e.g., the UI object 801 in FIG. 8) from the first position to the second position. For example, the UI object 801 may be a fingerprint authentication indication that guides the user to a touch position of a fingerprint.

For example, referring to parts (a) and (b) of FIG. 8, when the fingerprint 601 touched by the user of the electronic device 400 deviates, at least in part, from the UI object 801 and thereby causes a failure of fingerprint authentication, the processor 460 may change the position of the UI object 801 in consideration of such deviation, based on fingerprint position information acquired at the time of fingerprint registration.

At operation 1330, the processor 460 may display the UI object 801 changed to the second position to the user and then acquire again fingerprint information for authentication of the user of the electronic device 400.

FIG. 13B is a flow diagram illustrating a method for controlling a plurality of vibrating devices to acquire fingerprint information of a user in case of a failure of fingerprint authentication at an electronic device according to various embodiments of the disclosure.

Referring to FIG. 13B, when user's fingerprint authentication fails, the electronic device 400 according to various embodiments may control the vibration attributes (e.g., vibration frequency or vibration intensity) of the first and second vibrating devices 430 and 440 to inform the user about a relative direction from the position of a user's input for fingerprint authentication to the position of the fingerprint sensor through a tactile feedback (e.g., a directional vibration).

When user's fingerprint authentication fails, at operation 1350 the processor 460 may identify, from a plurality of pieces of user fingerprint registration information stored in the memory 450, fingerprint position information for fingerprint touch information having the highest similarity with fingerprint information for fingerprint authentication.

At operation 1360, based on the UI object (e.g., the UI object 801 in FIG. 8), the processor 460 may determine the vibration attributes (e.g., vibration frequency or vibration intensity) of the first and second vibrating devices 430 and 440 to correspond to the direction (or position) of user's touch information.

For example, referring to FIG. 10, the electronic device 400 according to various embodiments may indicate the position (or direction) of the fingerprint sensor 420 in a tactile manner (e.g., vibration feedback) through the first vibrating device 430 or the second vibrating device 440. For example, based on both fingerprint position information acquired in a fingerprint registration process and fingerprint position information acquired in a fingerprint authentication process, the electronic device 400 may indicate the direction of the fingerprint sensor 420 to the user by using the first vibrating device 430 or the second vibrating device 440. According to an embodiment, the first vibrating device 430 of the electronic device 400 may generate a vibration at the first position (e.g., the left side) of the fingerprint sensor 420. In addition, the second vibrating device 440 may generate a vibration at the second position (e.g., the right side) of the fingerprint sensor 420. Such a feedback using the vibration of the first or second vibrating device 430 or 440 may occur while a user's touch input is maintained.

At operation 1370, the processor 460 may control the vibration attributes of the first and second vibrating devices 430 and 440, based on the fingerprint information for user's fingerprint authentication, and acquire again fingerprint information for authentication of the user of the electronic device 400.

For example, referring to FIG. 10, the processor 460 of the electronic device 400 according to various embodiments may control the first vibrating device 430, which corresponds to the first area (e.g., the left side) of the fingerprint sensor 420, to be operated with the first attribute (e.g., vibration frequency and vibration intensity). In addition, the processor 460 of the electronic device 400 may control the second vibrating device 440, which corresponds to the second area (e.g., the right side) of the fingerprint sensor 420, to be operated with the second attribute (e.g., vibration frequency and vibration intensity).

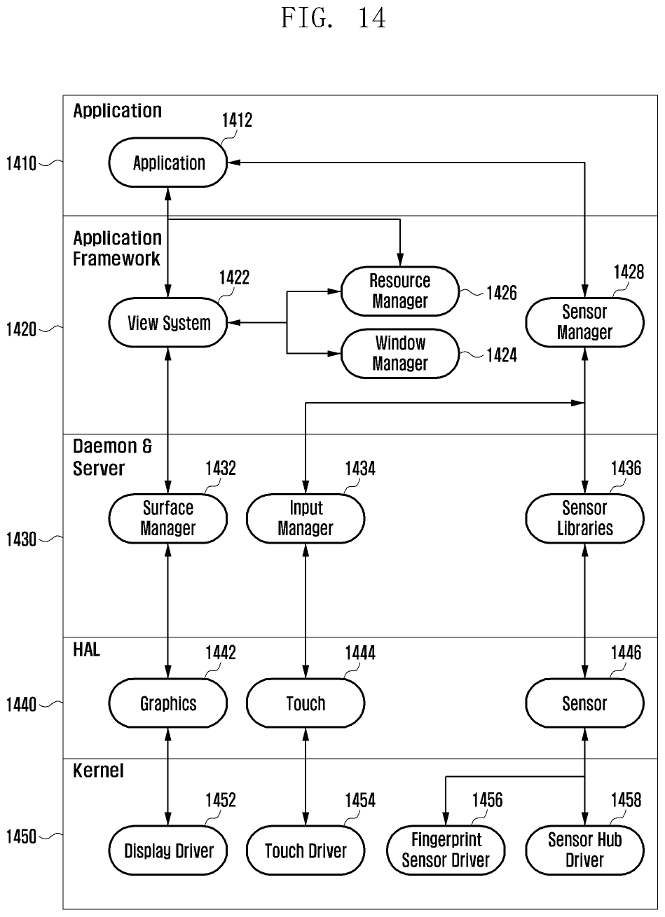

FIG. 14 is a diagram illustrating a system architecture of an electronic device according to various embodiments of the disclosure. The system architecture shown in FIG. 14 is a system architecture for a method of controlling the fingerprint sensor 420, based on a software layer structure stored in the memory 450 of the electronic device 400 according to various embodiments of the disclosure.

Referring to FIG. 14, the electronic device 400 according to various embodiments of the disclosure may store various layers of software in the memory 450.

According to various embodiments, an application layer 1410 may include at least one application 1412. An application framework layer 1420 may include a view system 1422, a window manager 1424, a resource manager 1426, and a sensor manager 1428. A daemon and server layer 1430 may include a surface manager 1432, an input manager 1434, and sensor libraries 1436. A hardware abstract layer (HAL) 1440 may include graphics 1442, a touch 1444, and a sensor 1446. A kernel layer 1450 may include a display driver 1452, a touch driver 1454, a fingerprint sensor driver 1456, and a sensor hub driver 1458.

For example, an operation of drawing a UI object (e.g., the UI object 801 in FIG. 8) through the touch screen 410 at the application 1412 of the electronic device 400 according to various embodiments of the disclosure will be described with reference to FIG. 14.

Referring to FIG. 14, the view system 1422 of the application framework layer 1420 may acquire information for constructing the UI object 801 at the request of the application 1412. The view system 1422 may determine a window set for containing the UI object 801 through the window manager 1424 and also determine a resource to be drawn on the window through the resource manager 1426.

According to an embodiment, the view system 1422 may construct the UI object 801 on the determined window through the provided resource. The constructed UI object 801 may be displayed on the display 414 of the touch screen 410 by using, for example, the surface manager 1432, the graphics 1442, and the display driver 1452.

For example, an operation of performing a function for fingerprint recognition through the fingerprint sensor 420 at the application 1412 of the electronic device 400 according to various embodiments of the disclosure will be described with reference to FIG. 14.

Referring to FIG. 14, when the application 1412 of the electronic device 400 performs a function that requires fingerprint recognition, the application 1412 may call and enable an application programming interface (API) of the sensor manager 1428 of the application framework layer 1420 to perform a fingerprint sensing function. For example, together with or in addition to calling the API for fingerprint sensing of the sensor manager 1428, the application 1412 may deliver touch information of the touch screen 410 displaying the UI object (e.g., the UI object 801 in FIG. 8) for fingerprint sensing to the sensor manager 1428.

According to an embodiment, the sensor manager 1428 may deliver, to the fingerprint sensor driver 1456 through the sensor libraries 1436 and the sensor 1446, a command for controlling the fingerprint sensor 420 to activate a fingerprint sensing area corresponding to coordinates in the received touch information. Then, based on the received command, the fingerprint sensor driver 1456 may control the fingerprint sensor 420. In addition, the sensor manager 1428 may receive information about a fingerprint sensing activation area and deliver it to the fingerprint sensor driver 1456. Then, the fingerprint sensor driver 1456 may acquire only information corresponding to the fingerprint sensing activation area from fingerprint information acquired through scanning and deliver the acquired information to a security area.

For example, another operation of performing a function for fingerprint recognition through the fingerprint sensor 420 at the application 1412 of the electronic device 400 according to various embodiments of the disclosure will be described with reference to FIG. 14.

Referring to FIG. 14, when the application 1412 of the electronic device 400 performs a function that requires fingerprint recognition, the application 1412 may display the UI object 801 to guide a fingerprint input on the display 414 of the touch screen 410 and wait for a user's fingerprint input in an input standby state. When fingerprint information is input from the user, the touch driver 1454 may deliver touch coordinates of the fingerprint information to the sensor manager 1428 through the input manager 1434. According to an embodiment, the sensor manager 1428 that receives the touch coordinates information may call the fingerprint sensing API and perform fingerprint sensing. The sensor manager 1428 may deliver, to the fingerprint sensor driver 1456, a command for controlling the fingerprint sensor 420 to activate a fingerprint sensing area corresponding to the received touch coordinates information. Then, based on the received command, the fingerprint sensor driver 1456 may control the fingerprint sensor 420.

While the disclosure has been described in detail with reference to specific embodiments, it is to be understood that various changes and modifications may be made without departing from the scope of the disclosure. Therefore, the scope of the disclosure should not be limited by embodiments described herein, but should be determined by the scope of the appended claims and equivalents thereof.

1. An electronic device comprising:
a display including a touch panel;
a fingerprint sensor formed in an at least partial area of the display; and
a processor,
wherein the processor is configured to:
display a graphical object in a first area including the at least partial area through the display;
acquire a fingerprint input through the fingerprint sensor and position information associated with the fingerprint input through the touch panel; and
display the graphical object in a second area including the at least partial area, at least based on the position information.

2. The electronic device of claim 1, further comprising:
a memory configured to store fingerprint information and position information corresponding to the fingerprint information,
wherein the processor is further configured to:
when the fingerprint input satisfies a predetermined condition, store fingerprint information corresponding to the fingerprint input and position information associated with the fingerprint input in the memory.

3. The electronic device of claim 1, further comprising:
a memory storing at least one piece of fingerprint information and position information corresponding to the at least one piece of fingerprint information,
wherein the processor is further configured to:
perform a comparison between position information associated with the fingerprint input and the position information corresponding to the at least one piece of fingerprint information stored in the memory; and
determine a position of the second area, at least based on a result of the comparison.

4. The electronic device of claim 1, further comprising:
a memory storing a plurality of pieces of fingerprint information and position information corresponding to the plurality of pieces of fingerprint information,
wherein the processor is further configured to:
perform a comparison between position information associated with the fingerprint input and the position information corresponding to the plurality of pieces of fingerprint information stored in the memory;
select at least one of the plurality of pieces of fingerprint information, at least based on a result of the comparison for the position information;
perform a comparison between the selected at least one piece of fingerprint information and fingerprint information corresponding to the fingerprint input; and
determine whether to perform authentication, at least based on a result of the comparison for the fingerprint information.

5. The electronic device of claim 1, wherein the processor is further configured to:
identify cumulative input information for a user's touch input through the touch panel; and
determine a position of the first area or a position of the second area, at least based on the cumulative input information.

6. The electronic device of claim 1, further comprising:
a plurality of vibrating devices,
wherein the processor is further configured to:
control at least one vibrating device corresponding to the first area among the plurality of vibrating devices to be operated with a first attribute; and
control at least one vibrating device corresponding to the second area among the plurality of vibrating devices to be operated with a second attribute.

7. The electronic device of claim 1, wherein the processor is further configured to:
change a size of the graphical object displayed in the second area including the at least partial area, at least based on the position information.

8. The electronic device of claim 1, wherein the processor is further configured to:
perform a comparison between position information associated with the first area and position information associated with the fingerprint input; and
determine a position of the second area, at least based on a result of the comparison.

9. A method for displaying a graphical object for a fingerprint input in an electronic device including a display including a touch panel, a fingerprint sensor formed in an at least partial area of the display, and a processor, the method comprising:
at the processor, displaying a graphical object in a first area including the at least partial area through the display;
at the processor, acquiring a fingerprint input through the fingerprint sensor and position information associated with the fingerprint input through the touch panel; and
at the processor, displaying the graphical object in a second area including the at least partial area, at least based on the position information.

10. The method of claim 9, further comprising:
at the processor,
when the fingerprint input satisfies a predetermined condition, based on fingerprint information and position information corresponding to the fingerprint information stored in a memory, storing fingerprint information corresponding to the fingerprint input and position information associated with the fingerprint input in the memory.

11. The method of claim 9, further comprising:
at the processor,
performing a comparison between position information associated with the fingerprint input and position information corresponding to at least one piece of fingerprint information stored in a memory; and
determining a position of the second area, at least based on a result of the comparison.

12. The method of claim 9, further comprising:
at the processor,
performing a comparison between position information associated with the fingerprint input and position information corresponding to a plurality of pieces of fingerprint information stored in a memory;
selecting at least one of the plurality of pieces of fingerprint information, at least based on a result of the comparison for the position information;
performing a comparison between the selected at least one piece of fingerprint information and fingerprint information corresponding to the fingerprint input; and
determining whether to perform authentication, at least based on a result of the comparison for the fingerprint information.

13. The method of claim 9, further comprising:
at the processor,
identifying cumulative input information for a user's touch input through the touch panel; and
determining a position of the first area or a position of the second area, at least based on the cumulative input information.

14. The method of claim 9, further comprising:
at the processor,
controlling at least one vibrating device corresponding to the first area to be operated with a first attribute; and
controlling at least one vibrating device corresponding to the second area to be operated with a second attribute.

15. The method of claim 9, further comprising:
at the processor,
changing a size of the graphical object displayed in the second area including the at least partial area, at least based on the position information; or
performing a comparison between position information associated with the first area and position information associated with the fingerprint input, and determining a position of the second area, at least based on a result of the comparison.
